(19) United States
(12) Patent Application Publication
(10) Pub. No.: US 2020/0280201 A1
(43) Pub. Date: Sep. 3, 2020

(54) Charging Unit with Display Device

(71) Applicant: INNOGY SE, Essen (DE)

(72) Inventors: Stefan HELNERUS, Arnsberg (DE); Jürgen WAFFNER, Essen (DE); Christian MÜLLER-WINTERBERG, Dorsten (DE)

(73) Assignee: innogy SE, Essen (DE)

(21) Appl. No.: 16/615,545

(22) PCT Filed: May 8, 2018
(86) PCT No.: PCT/EP2018/061903

§ 371 Date: Nov. 21, 2019

(30) Foreign Application Priority Data
May 23, 2017 (DE) 10 2017 111 208.1

(51) Int. Cl. H02J 7/00; B60L 53/30; B60L 53/31

(52) U.S. Cl. CPC H02J 7/0047; B60L 53/31; B60L 53/305

(57) ABSTRACT

The subject-matter relates to a charging unit having a basic body, a housing at least partially surrounding the basic body, and a display device for displaying a status which is visible at least on the front side of the housing.

### FIELD OF INVENTION

The object relates to a charging unit (CU), which can be integrated into different charging infrastructure solutions (e.g. charging station or charging box) for charging electric vehicles, comprising the features of the preamble of claim 1.

### BACKGROUND OF THE INVENTION

Charging stations or charging boxes for charging electric vehicles are usually located at the homes of the owners or the users of the electric vehicles (e.g. in their garage), at the workplace or in publicly accessible car parks in order to be able to charge the electric vehicles. Such charging boxes can, for example, be installed on a wall. Charging stations can, for example, be free-standing on the floor. To enable electric vehicles to be charged, charging stations or charging boxes are electrically connected to an energy source (e.g. a house connection or a station providing access to an energy network).

In addition the charging of electric vehicles electrically connected to the charging infrastructure solutions, such solutions can also be used to charge batteries that are not located in an electric vehicle during the charging, such as spare batteries or the like.

Oftentimes, such charging infrastructure solutions are installed in places where, for example, it is relatively dark (e.g. in a garage). The handling for an owner or user of an electric vehicle can then sometimes be difficult, e.g. an optically indicated status of the charging station or charging box is not visible. In the case of publicly accessible charging stations, it is often not possible to tell from a distance whether a charging station is free to connect an electric vehicle or not. Due to the charging cable, which can have a length of about 5 m, for example, a vehicle parked directly in front of the charging station is sometimes not a clear indication of an occupied charging station.

### SUMMARY OF SOME EXEMPLARY EMBODIMENTS OF THE PRESENT INVENTION

For example, in order to eliminate defects in the user interface used of the charging infrastructure solution at low cost, it may be provided to detachably arrange a charging unit comprising this user interface on the charging station. In the area of publicly accessible charging stations, such a charging unit may also not be detachably attached to or be comprised by the charging station.

Based on the prior art described above, the object is to provide a user-friendly charging unit that simplifies the handling of the charging infrastructure solution by an owner or user of an electric vehicle.

This object is solved in that the charging unit comprises at least one proximity sensor and at least one light sensor, the proximity sensor detecting objects in the region of the outside of the housing, and the light sensor detecting a brightness and/or darkness in the region of the outside of the housing.

It has been recognized that the essential technology for controlling the charging unit and/or charging station or charging box (e.g. control circuit, user interface, input/output means) can be installed in a basic body of the charging unit. For example, a keyboard or the like can be used as an input means. For example, a display device or the like can be provided as an output means, so that interaction with an owner or user of an electric vehicle is possible. A combined input/output interface is also conceivable, for example a touch-sensitive display, which can display information as well as receive input from the owner or user.

A charging infrastructure solution within the meaning of the present subject-matter may be understood as a charging point at the place where an owner or user of an electric vehicle connects (e.g. plugs in) the charging cable necessary to charge a battery of the electric vehicle on the grid side.

A charging unit (in this specification also referred to as a CU) in the sense of the present subject-matter can be understood, for example, as a interchangeable element which can be arranged on a charging infrastructure solution (e.g. detachable) and which comprises the claimed means. The charging unit can therefore be arranged, detached on a charging infrastructure solution (e.g. a charging box or charging station), and therefore be interchangeable, particularly in the manner of a module. In the event of a defect in one of the means comprised by the charging unit, only the charging unit needs to be replaced, and in particular not the charging infrastructure solution. Alternatively, such a charging unit may be comprised by a charging station or charging box. In this case, in particular, the charging unit can be arranged so firmly on the charging station or charging box that it is not possible to detach the charging unit from outside of the charging station or charging box. Alternatively, the charging unit can be attached to the charging station or charging box so that it cannot be removed.

The proximity sensor can be arranged on the basic body of the charging unit. In the sense of the present subject-matter, this can be understood to mean that the proximity sensor is arranged in the area of the lateral surface of the basic body. However, the proximity sensor can also be partially arranged inside of the basic body. The proximity sensor is preferably arranged on one side of the body facing the inside of the housing. In particular, the proximity sensor is arranged on an outer surface of the basic body. The arrangement of the proximity sensor is designed in such a way that the proximity sensor preferably detects objects in the area of the outside of the housing without requiring contact. In the case that the proximity sensor is arranged on the basic body, for example, the housing is at least partially transparent, in particular the housing can be transparent at least in the area covering the proximity sensor. In this way, depending on the functional principle of the proximity sensor, it can be ensured that objects in the area of the outside of the housing can be detected by the proximity sensor.

Alternatively or additionally (in the case of a plurality of proximity sensors), the proximity sensor(s) is (are) arranged on the housing and electrically connected to the basic body. In particular, the proximity sensor in this case can be arranged on one of the outer sides of the housing, for example.

The charging unit also comprises a light sensor for detecting darkness and/or brightness. The light sensor, for example, is a sensor that can convert incident light into an electrical signal. For example, the light sensor is an optoelectronic sensor. For example, the light sensor can also be arranged on the basic body of the charging unit. Information gathered by the light sensor may, for example, be transmitted to a control circuit. Additionally or alternatively, the light sensor can, for example, be surrounded by the basic body of a charging station or a charging box and be connected to the basic body of the charging unit in such a way that, in particular, information detected by the light sensor can be transmitted from the latter to an entity (e.g. a control circuit) of the charging unit.

For example, one or more functions of the charging unit can be controlled and/or regulated on the basis of the information gathered by the light sensor. For example, the light sensor can be used to switch on the display device for ambient lighting if the light sensor detects information that is indicative of the presence of darkness in the surroundings of the light sensor. This increases energy efficiency as the display device is only switched on when actually needed. For example, the light sensor can detect brightness information, where the brightness information is indicative of ambient brightness and/or ambient light color. The term environment refers in particular to the area of the outside of the housing of the charging unit.

In addition, the charging unit may include one or more further optional sensors. The one or more further sensors can be, for example, further proximity sensors and/or light sensors. One or more further sensors may be, for example, biometric sensors (e.g. fingerprint sensor) to identify and authenticate an owner or user of an electric vehicle. This ensures, for example, that only authorized persons can start, control or similar functions of the charging process. The one or more further sensors can, for example, be stimulus sensors of the environment of the charging unit.

By means of a stimulus sensor, a temperature, a volume and/or a humidity in the surrounding area of the charging unit can be detected. For example, the display device may be controlled and/or regulated at least in part based on information gathered by the stimulus sensor. For example, depending on the temperature, the display can light up brighter or darker.

In addition, information may or may not be signaled to the owner or user of an electric vehicle based, for example, on a volume level in the vicinity of the charging unit. For example, in a quiet environment, the charging unit can be controlled in such a way that no sounds or the like (e.g. to confirm a successful input of information e.g. via a user interface of the charging unit) are played. Such a control of the charging unit can be carried out additionally or alternatively on the basis of the information gathered/detected by the light sensor. For example, information detected by the light sensor may be indicative of darkness in the vicinity of the charging unit (e.g. at night). In order not to disturb other people (e.g. residents), for example, it is therefore not necessary for the charging unit to play sounds at night.

Based on humidity information, for example, the display device can be controlled and/or regulated. For example, when it rains, the display device may sometimes change the display of information, such as the intensity of the light displayed by the display device.

Additionally or alternatively, a charging power detected by a stimulus sensor, for example, can control and/or regulate the display device. For example, at a high charging power, which charges an electric vehicle connected to the charging unit, the color, intensity or the like of the light from the display device can be changed. For example, additionally or alternatively depending on an owner or user of an electric vehicle and/or an owner of the charging unit, the appearance of the charging unit may be changed by a corresponding change in the light displayed by the display device (e.g. depending on the owner of an electric vehicle connected to the charging unit, the color of the light of the display device may be changed). The corresponding information can, for example, be stored in a database. For example, an owner or user of an electric vehicle and/or an owner of the charging unit can be identified by means of identification information, and the database contains corresponding control information for changing the appearance of the charging unit in addition to the identification information.

In an exemplary embodiment, the basic body can be detachably connected to a base body of a charging station or charging box so that the charging unit may be arranged on the charging station or charging box. The base body of the charging station or charging box may be fixed (e.g. immovable). The base body may, for example, be arranged in a garage or on a garage wall, as is the case with a charging box. Since the basic body is detachably connected to the base body, the basic body is particularly interchangeable. This also makes it possible to exchange the charging unit comprising the basic body. If, for example, a defect occurs in one of the means of the charging unit (e.g. the indicator), then only the charging unit needs to be replaced comprehensively with the defective means.

The term “objects” in the sense of the present subject-matter may be understood to cover both objects and persons. For example, a person can approach the charging unit as a user, and this is detected accordingly by the proximity sensor. Furthermore, an electric vehicle, for example, can approach the charging unit and this is detected accordingly by the proximity sensor. The proximity sensor may be configured to detect only objects or people as well as objects. Alternatively, the proximity sensor may also be configured to detect both objects and people as well as objects.

By means of the display device for displaying a status (e.g. of the charging unit and/or charging station and/or electric vehicles connected thereto), the essential information relating to the charging of an electric vehicle may be displayed. Additionally, the display device may display one or more further status information, e.g. of a charging station and/or a charging unit and/or electric vehicles connected thereto. The display device may, for example, be designed for (i) optical, (ii) acoustic, (iii) haptic or (iv) a combination thereof, playback of information (e.g. corresponding to control information comprising the information and generated by a control circuit).

If, for example, an object is detected outside of the housing, this may be represented by a status, for example. For example, the display device may be switched on so that it lights up and, for example, illuminates the surroundings of the charging unit. Such an switched on display device of the charging unit may then, for example, offer an orientation to an owner or user in order to facilitate a possible charging of an electric vehicle.

The battery status of a connected battery (e.g. of an electric vehicle) may represent a status, for example. For example, the display device may display the available capacity of a connected battery or the like as a status. Alternatively or additionally, an action performed by the charging unit may represent a status of the charging unit. For example, the display device may be used to indicate (e.g. optically) that a charging process of a battery is in progress or that a started charging process of a battery has been completed and/or an error of the charging unit or an error has occurred while charging a battery.

Furthermore, a charging unit occupancy, for example, can represent a status. For example, the display device may be used to display information indicative of a free or occupied charging unit. Further examples for one or more statuses are conceivable. The above examples are non-limiting for the item.

In an exemplary embodiment, the proximity sensor capacitively detects metallic and non-metallic objects. Objects in the vicinity of the proximity sensor change the electric field between the proximity sensor and the earth field. This change in the electric field may be evaluated by the proximity sensor so that objects in the area of the surrounding of the housing may be detected.

In another exemplary embodiment, the proximity sensor detects movement of objects in the region of the outside of the housing. In addition to detecting whether objects are near the proximity sensor, the proximity sensor may also detect whether objects are moving or have moved. A movement of objects may be detected by the proximity sensor as information, for example.

If a plurality of proximity sensors is used, it is possible to detect movements along at least one axis between the proximity sensors by a difference-method with regard to their direction of movement. This means that a movement along at least one axis may be detected by at least two proximity sensors.

In an exemplary embodiment, the proximity sensor is a radar sensor, a temperature sensor or an ultrasonic sensor.

For example, a radar sensor emits bundled electromagnetic waves and receives those of the emitted electromagnetic waves that are reflected by one or more objects. From the waves received and reflected by at least one object, the following information may be obtained, for example:
(i) the angle or direction to the object;
(ii) the distance to the object (e.g. determined from the time difference between emitting and receiving the electromagnetic waves);
(iii) the relative movement between the radar sensor and the object;
(iv) the distance traveled and the absolute speed of the object (e.g. determined from several individual measurements);
(v) a combination thereof.

A temperature sensor may, for example, be a pyrometer or a thermal imaging camera, each of which can detect without contact thermal radiation emitted by one or more objects.

An ultrasonic sensor may, for example, be configured to locate objects by means of emitted (ultra-) sound pulses. Dynamic and/or electrostatic loudspeakers and, in particular, piezo loudspeakers, e.g. membrane-coupled plates made of piezoelectric ceramic, which are caused to oscillate by reversing the piezo effect, are suitable for generating (ultra) sound pulses (e.g. in air).

In a further exemplary embodiment, the display device is arranged on the basic body and the housing is at least partially transparent at least in the region covering the display device.

In this way it may be ensured, for example, that information displayed by the display device is visible from the outside (e.g. from an owner or user of an electric vehicle).

A further embodiment is characterized in that the display device comprises at least one optical fiber.

The optical fiber, for example, is a light tube. The optical fiber, for example, is made of a (highly) transparent polycarbonate. In addition, one or more decoupling elements (e.g. microprisms or diffusers) may be arranged in a cavity formed by at least one optical fiber, so that light can emerge from the optical fiber via the decoupling elements.

For example, to decouple light put into the optical fiber, the optical fiber can have decoupling elements that conduct part of the light flow to the outside. For example, light can emerge from the cavity via the (highly) transparent polycarbonate from the optical fiber. For example, a light source feeds light into the optical fiber (light is emitted by the light source), and the decoupling elements (e.g. microprisms) break this light so that the put light may emerge at the location of the decoupling element in the cavity of the optical fiber. Accordingly, the light at this point of the optical fiber is visible from the outside.

In a further exemplary embodiment the display device comprises at least one light source which emits or feeds light into one end of the at least one optical fiber.

The light source, for example, is a light-emitting diode (LED). Alternatively, the light source may be an organic light-emitting diode (OLED) made of organic semiconducting materials. For example, an LED driver may be connected up in series of the LED or OLED (e.g. an LED driver with about three to four watts of power). For example, the LED driver may be arranged on the basic body. Alternatively, the light source is, for example, a laser light source. For example, a laser light source generates electromagnetic waves with high intensity and sharp bundling of the light (also known as laser beams).

The display device may also comprise, for example, light modulation means which are connected to the light source in such a way that a modulation of a light performed by the light modulation means is put (e.g. emitted) into the optical fiber in a correspondingly modulated manner by the light source.

By modulating the light emitted by the light source, different light signals may, for example, be put into the optical fiber with one light source only. For example, the different light signals may be put sequentially from the light source into the optical fiber, so that due to the frequency the effect is given for a human observer that the different light signals are put simultaneously into the optical fiber.

In a further exemplary embodiment, in a first region of the optical fiber facing the light source are provided a lower number of decoupling elements compared to a second region of the optical fiber being further away from the light source than the first region.

In particular in order to enable a uniform emission of light via the decoupling elements (e.g. microprisms) from the optical fiber, fewer such decoupling elements may be arranged closer to the light source emitting the light into the optical fiber than in the second region which is further away from the light source. Due to the arranged decoupling elements within the optical fiber, a large number of light refractions occur to the emitted light. Each refraction of the light by one of the decoupling elements, for example, reduces the intensity of the light. Consequently, in order to achieve the same intensity of the light emitted from the optical fiber via the decoupling elements in the area furthest away from the light source than in the area closer to the light source, more decoupling elements may be arranged in this area. The first region has a lower absolute number of decoupling elements than the second region. In the first region, the decoupling elements are arranged less densely (number of decoupling elements per area) than in the second region.

In an exemplary embodiment, the at least one optical fiber is divided into at least two segments, wherein in particular the at least two segments are configured to display information differing from one another.

The at least two segments may, for example, be identical with the first region and the second region of the optical fiber.

The display device may, for example, be a multi-segment display device, e.g. the display device has several different segments (e.g. sections). For example, the optical fiber may be illuminated differently by the display device in different regions to enable such a multi-segment display device.

In particular, different information about the at least two segments may be displayed simultaneously. For example, in a first segment, information indicative of the status of a battery connected to the charging unit may be displayed, and in a second segment, information indicative of the status of the charging unit may be displayed. For example, the first segment may indicate that the battery is being charged and the second segment may indicate that the charging station is occupied.

A plurality of segments may also be possible. These segments may, for example, represent a respective percentage of the charging status of a battery or the like. In the event that the display device is configured, for example, to be a luminous ring surrounding the housing, this state of charge may be reproduced as a percentage of the state of charge of a battery connected to the charging unit, for example, by appropriate lighting of the segments. For example, in a charging state where a connected battery is 70% charged, 70% of the surface area of the display device emits light enabled by the segments.

In a further exemplary embodiment, the at least two segments of the display device display divergent light as information. For example, a first segment may be “switched on” so that light emerges from this region of the optical fiber. A second segment may be “switched off” simultaneously, so that no light emerges from this region of the optical fiber. Furthermore, both segments may be switched on, whereby, for example, the first segment lights up in a first color (e.g. red) and the second segment lights up in a second color (e.g. green).

For example, the at least two segments may display divergent light at the same time. The term “at the same time” within the meaning of the present subject-matter may comprise a sequential displaying of divergent light which is displayed sequentially and alternately in the at least two segments but is perceptible to a human observer as being simultaneously displayed. For example, this may be achieved if the light in the at least two segments changes with a frequency of at least 25 Hz.

In an exemplary embodiment, at least one of the following parameters of the light emitted by the light source may be configurable in the optical fiber:
(i) light temperature;
(ii) brightness;
(iii) color;
(iv) intensity;
(v) frequency;
(vi) or a combination thereof.

For example, the light temperature may be given in Kelvin.

The brightness may, for example, be a percentage, wherein, for example, 100% corresponds of the maximum possible brightness of the light emitted by the light source into the optical fiber. At 0%, no light at all is emitted from the light source into the optical fiber and corresponds to a deactivated light source. Values between 0% and 100% may, for example, correspond to dimmed light. The display device may, for example, be dimmable via this parameter.

For example, the color can include an RGB value or the like, so that the light source lights up in the color corresponding to the RGB value.

The intensity may be, for example, a percentage, wherein, for example, 100% corresponds to the maximum possible intensity of the light emitted by the light source into the optical fiber. At 0%, no light at all is emitted from the light source into the optical fiber and corresponds to a deactivated light source. Values between 0% and 100% may, for example, correspond to a reduced intensity of the maximum possible light provided by the light source.

The frequency may, for example, be given in Hz and may be adjusted by means of a light modulation. The frequency may be used, for example, for enabling the light source to display two or more different light signals.

In a further exemplary embodiment, the basic body comprises a control circuit which detects one or more signals from the at least one proximity sensor and/or the at least one light sensor and/or a battery connected to the charging unit (e.g. of an electric vehicle) and generates control information for the display device at least partially based on the detected one or more signals.

The control circuit, for example, is arranged in the basic body to evaluate the measured values gathered by at least one proximity sensor. The control circuit evaluates signals from the at least the proximity sensor. Additionally, the control circuit may evaluate signals from one or more further sensors (e.g. light sensor) and/or from a battery connected to the charging unit and/or the charging station. The control circuit may then generate control information (e.g. a control signal) which is used to control the display device. In an exemplary embodiment, the display device displays information according to the generated control information.

The control circuit may also be partially located outside the housing of the charging unit, for example in the form of a central control unit of a home automation system. In this case, the information (e.g. signals) from the proximity sensor and/or the light sensor and/or the further sensors in the control circuit may be gathered, the gathered information may be evaluated and the control information thereof may, for example, be performed and/or controlled for the display device outside of the charging unit. In particular, on the basis of the derived control information, the light source emits light into the optical fiber according to the generated control information. In the event that the control circuit generates a plurality of control information, the light source may, for example, emit light into the optical fiber according to the generated plurality of control information.

In an exemplary embodiment, the control circuit generates control information indicative of an activation of the display device at a detection of objects by the at least one proximity sensor. Accordingly, the light source may be switched on, for example, so that light emerges from the optical fiber via the decoupling-out elements. In another exemplary embodiment, the control information at least partially comprises a parameter for adjusting the light emitted by the light source. If the control information comprises one or more of such parameters, e.g. (i) light temperature; (ii) brightness; (iii) color; (iv) intensity; (v) frequency; (vi) or a combination thereof, the light source may emit light into the optical fiber in accordance with said one or more parameters.

In an exemplary embodiment, the control circuit generates, at least partially, based on brightness information detected by the at least one light sensor, control information indicative of an activation and/or adjusting of the display device. For example, the display device may be adjusted dependent on an external value of light in the surrounding of the housing of the charging unit by means of a correspondingly generated control information. For example, the brightness of the information displayed by the display device (e.g. emitted light) may be increased in a (e.g. very) bright environment of the charging unit so that the information displayed by the display device (e.g. emitted light) is or remains visible despite the bright environment. Additionally, for example, the brightness of the information displayed by the display device (e.g. emitted light) may be changed in an environment in which the ambient light has a certain light temperature (e.g. substantially perceived as blue light) so that the information displayed by the display device (e.g. emitted light) is or remains visible.

In an exemplary embodiment, the control circuit, in response to a signal indicative of the status of a battery connected to the charging unit, generates a control information indicative of a status information of the charging unit. At least partially based on the control information indicative of the status information of the charging unit, for example, the display device may display the corresponding information.

If the charging unit has at least two proximity sensors, the control circuit may evaluate the gathered information (e.g. signals) from at least two proximity sensors. This may enable the simultaneous detection of at least two objects in the surrounding of the housing.

In an exemplary embodiment, the display device comprises a diffuser for uniformly emitting light

For example, the diffuser is arranged on the optical fiber and at least partially covers it. Light emitted from the light source into the optical fiber, for example, exits the optical fiber via the decoupling elements and then hits the diffuser, which scatters the incoming light in a uniform manner. Alternatively, the diffuser may, for example, be a part of the housing covering the display device, or may be surrounded by this part of the housing.

In a further exemplary embodiment, the light source varies the intensity of the emitted light as a function of a predetermined ageing curve. The ageing curve reflects the ageing of the light source, wherein in particular the brightness and intensity of the light emitted by the light source decreases with ageing (e.g. due to the operation of the light source). For example, to keep the intensity of the light emitted by the light source identical over time, an aging curve may be used. For example, the aging curve causes the intensity and/or brightness of the light emitted by the light source to be increased or decreased.

In an exemplary embodiment, at least one optical fiber is arranged on the basic body in such a way that the optical fiber at least partially surrounds the outer edge of the housing. This enables a visually appealing design of the housing, as the display device acts like a light ring surrounding the housing. The shape of this light ring, for example, may essentially be round. Alternatively, the shape of light ring e.g. could be in the form of a circle. The shape of the light ring may be rectangular or square, for example, if the housing has a corresponding shape. Alternatively, the optical fiber may be arranged differently so that the display device appears to be arranged within a surface of the housing. For example, the optical fiber may be arranged in strips on the basic body.

Further advantageous exemplary embodiments are found in the following detailed description of some exemplary embodiments, especially in conjunction with the figures. However, the figures should only serve the purpose of clarification, but not to determine the claimed scope. The figures are not true to scale and should only reflect the general concept as an example. In particular, features contained in the figures should by no means be regarded as a necessary component.

### BRIEF DESCRIPTION OF THE DRAWINGS

In the figures show

FIG. 1 a view of a section of a charging station according to an embodiment;

FIG. 2 a view of a section of a charging station according to an embodiment;

FIG. 3 a view of a section of a charging station according to an embodiment;

FIG. 4 a block diagram of a charging unit according to an embodiment; and

FIG. 5 a schematic cross-sectional view of a charging unit according to an embodiment.

### DETAILED DESCRIPTION OF SOME EXEMPLARY EMBODIMENTS OF THE PRESENT INVENTION

The present subject is described in the following on the basis of exemplary embodiment forms.

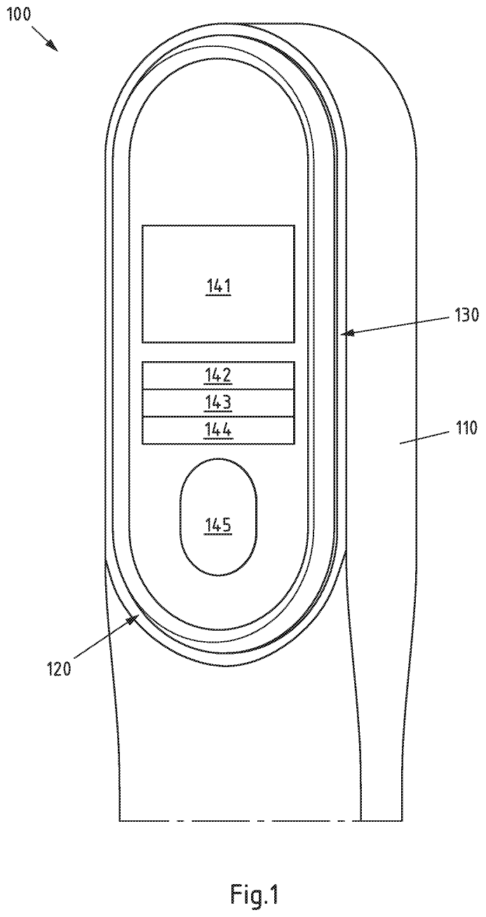

FIG. 1 shows a view of a section of a charging station according to an embodiment.

The charging station 100 comprises a base body 110, on which a charging unit 120 is detachably arranged. The charging unit 120 comprises a basic body 150, which is covered in FIG. 1 by a housing 160 at least partially surrounding the basic body 150. The charging unit 120 further comprises a user interface 141, a proximity sensor 142, a light sensor 143, one or more optional sensors 144, a connection 145 for a charging cable and a display device 130 visible at least on the front end of the housing 160. To charge the battery of an electric, a charging cable connected to the electric vehicle and to the connection 145 may be used.

The charging unit 120 may, for example, be arranged in a reception of the charging station 100 designed in accordance with the rear side of the charging unit 120. The charging unit 120 may also have, for example, a communication connection (e.g. wireless or wired) to the charging station 100. For example, the communication interface may be used to transmit information, which, for example, is gathered by the charging station 100, to the charging unit for further processing.

The user interface 141 may be used, for example, to gather input from an owner or user of an electric vehicle. For example, the owner or user can start and/or stop the charging process of an electric vehicle connected to the charging station 100 by entering an appropriate input in the user interface 141. The user interface 141 may, for example, be a touch-sensitive display or have capacitive touch points.

The proximity sensor 142 detects objects in the region of the outside of the housing. In particular, the proximity sensor 142 may detect a movement of objects in the region of the outside of the housing 160.

The light sensor 143 detects a brightness in the region of the outside of the housing. In particular, the light sensor may detect 143 parameters of the light in the region of the outside of the housing. Parameters of light may be, for example, (i) light temperature; (ii) brightness; (iii) color; (iv) intensity; (v) frequency; (vi) or a combination thereof, to name but a few non-limiting examples.

Optionally, one or more further sensors 144 may be comprised, such as a biometric sensor and/or a stimulus sensor for sensing a temperature, volume and/or humidity in the vicinity of the charging unit.

The display device 130 is arranged on the basic body 150. The housing 160 is at least partially transparent in the area covering the display 130.

For example, the display device 130 may comprise at least one optical fiber. The optical fiber may be arranged on the basic body 150 in such a way that the optical fiber extends along the circumferential edge of the charging unit 120. At present, the display device 130 is essentially oval in shape.

Addition, the display device 130 may comprise at least one light source which emits light into one end of the at least one optical fiber. If light is emitted into the optical fiber, the emitted light may emerge to the outside via decoupling elements arranged in the optical fiber, so that the display device 130 lights up.

FIG. 1 shows that the display device 130 illuminates in one color over the entire oval shape. For example, the display device 130 may light up brightly to illuminate the area surrounding the charging station 100.

The proximity sensor 142 may, for example, detect that a metallic (e.g. an electric vehicle) or a non-metallic object (e.g. an owner or user of an electric vehicle) is approaching. A control circuit arranged on the basic body 150 detects corresponding one or more signals the proximity sensor 142 may have gathered by the object approaching the proximity sensor. Based on these one or more signals, the control circuit may generate control information for the display device 130 so that, for example, the display device lights up brightly and accordingly illuminates the environment of the charging station 100.

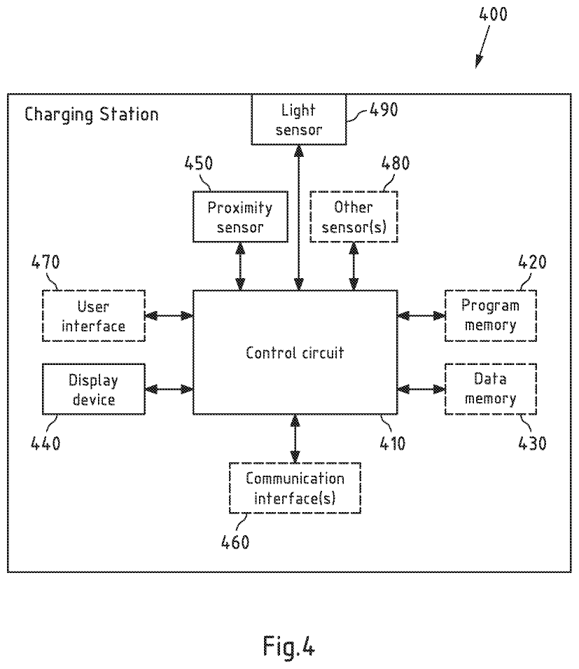

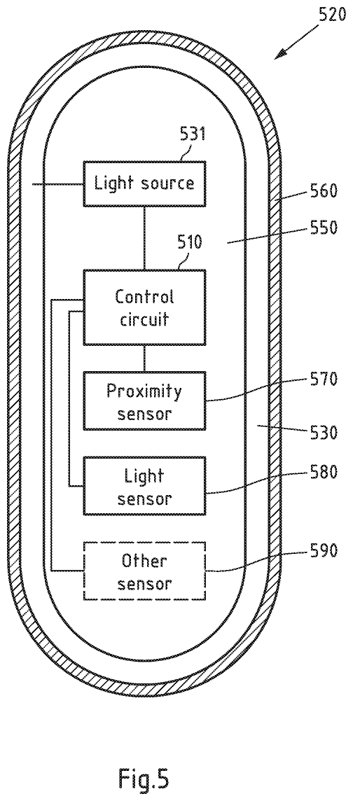

The light sensor 143 may, for example, detect whether, for example, a (very) bright environment prevails in the region outside of the charging unit 120. For example, the light sensor 143 may detect the light temperature in the region outside of the charging unit 120. Based on these one or more signals, the control circuit (e.g. control circuit 410 according to FIG. 4, or control circuit 510 according to FIG. 5) may generate control information for the display device 130, so that the display device 130 is increased in its brightness, for example, and/or the light temperature of the light displayed by the display device 130 is changed.

The control circuit (e.g. control circuit 410 according to FIG. 4, or control circuit 510 according to FIG. 5) may generate control information for controlling the display device 130 at least partially based on information gathered by the proximity sensor 142 and the light sensor 143, wherein the display device 130 illuminates, on the basis of the generated control information, for example in a color and brightness determined by the control information.

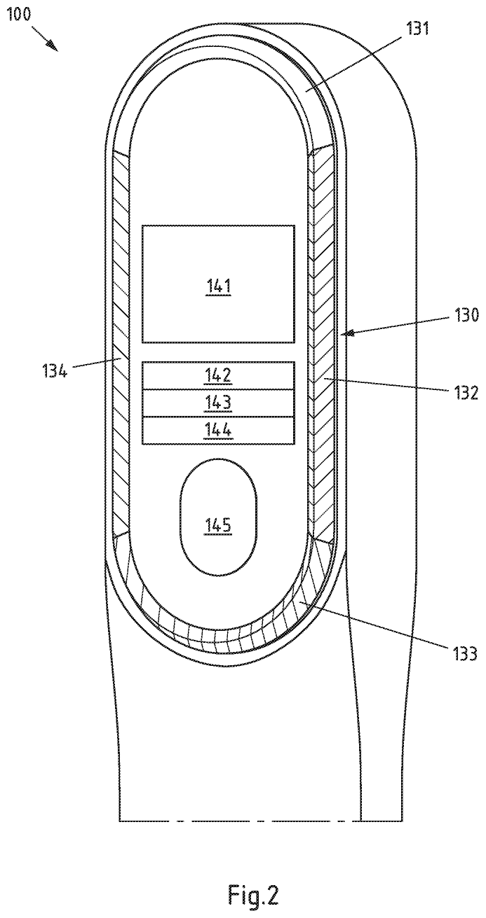

FIG. 2 shows a view of a section of a charging station according to an embodiment.

In contrast to FIG. 1, the display device 130 is divided into four segments 131 to 134. In each of these four segments 131 to 134, different information may be presented. For example, each of the four segments 131 to 134 may light up in a different color or the four segments 131 to 134 may be controlled alternately (e.g. clockwise) to light up, whereby, for example, information may be visualized as an indication of a charging process currently being carried out on an electric vehicle. The differently shaded areas of the four segments 131 to 134 in FIG. 2 are intended to illustrate this possibility of presenting information that differs from one another.

To make this possible, the optical fiber comprised by the display device 130 is divided into four segments 131 to 134. Each of these four segments 131 to 134 has a different number of decoupling elements, so that light emitted into the optical fiber may emerge the optical fiber via the decoupling elements and a corresponding segment lights up according to the light emitted. The examples given are not limited to the subject-matter.

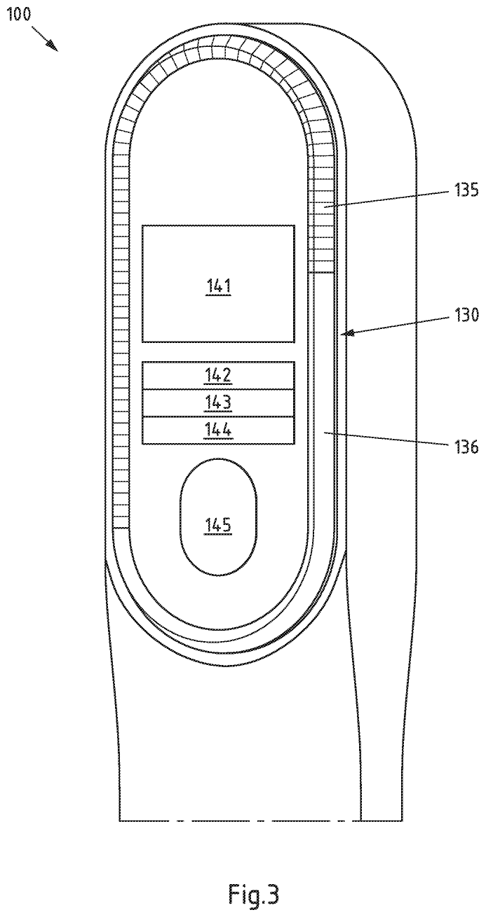

FIG. 3 shows a view of a section of a charging station according to an embodiment.

In contrast to FIG. 1 and FIG. 2, the display device 130 is divided into a plurality of segments 135 and 136. The respective segments 135 and 136 comprise a plurality of segments in turn. The display device shows the current charging status of a battery, for example of an electric vehicle, which is connected to the charging station 100. The segments which represent the charging status in the example shown in FIG. 3 are provided with the reference symbol 135. Segments 136, on the other hand, are not activated as segments and therefore do not display information to a user.

For example, all segments 135 and 136 of the display device 130 could light up in green to indicate a status of the charging unit after which the battery connected to the charging station is fully charged. For the charging status of a battery of an electric vehicle shown in FIG. 3, the battery is approximately ⅔ charged.

FIG. 4 shows a block diagram of a charging unit 400 according to an embodiment.

The charging unit 400 comprises a 410 control circuit, which may be programmed, for example, to perform and/or control the method described above and below.

The charging unit 400 also comprises a display device 440, and a proximity sensor 450, a light sensor 490, an optional communication interface 460, an optional user interface 470, and optionally (a) further sensor(s). The optional further sensor(s) 480 may be a biometric sensor or a stimulus sensor.

The control circuit 410 may, for example, be a processor, e.g. a microprocessor, a microcontroller unit such as a microcontroller, a digital signal processor (DSP), an application-specific integrated circuit (ASIC) or a field programmable gate array (FPGA).

If the control circuit 410 is a processor, the charging unit 400 preferably comprises an optional program memory 420, and an optional data memory 430.

The processor may execute program instructions stored in the optional program memory 420. For example, program memory 420 is a non-volatile memory such as a flash memory, a magnetic memory, an EEPROM memory (electrically erasable programmable read-only memory) and/or an optical memory. Additionally, a working memory may be provided, for example a volatile or non-volatile memory, in particular a random access memory (RAM) such as a static RAM memory (SRAM), a dynamic RAM memory (DRAM), a ferroelectric RAM memory (FeRAM) and/or a magnetic RAM memory (MRAM). For example, the processor may store intermediate results or something similar in the main memory.

Program memory 420 is preferably a local data medium permanently connected to the processor. For example, data media that are permanently connected to the processor are hard disks that are built into the charging unit 400. Alternatively, the data medium may also be a data medium which may be detachably connected to the charging unit 400, such as a memory stick, a removable data carrier, a portable hard disk, a CD, a DVD and/or a floppy disk.

The optional program memory 420 may contain the operating system from the charging unit 400, which is at least partially loaded into working memory and executed by the processor when the charging unit is switched on. In particular, when the charging unit 400 is switched on, at least a part of the core of the operating system is loaded into the working memory and is executed by the processor. The operating system of data processing system 1 shall preferably be a Windows, UNIX, Linux, Android, Apple iOS and/or MAC operating system.

The operating system enables the use of the charging unit 400 for data processing. For example, it manages resources such as data memory 430 and program memory 420, communication interface(s) 460, the optional user interface 470, makes basic functions available to other programs, among other things through programming interfaces, and controls the execution of programs.

The control circuit 410 designed as a processor controls the communication interface(s) 460, whereby the control of the communication interface(s) 460 is enabled, for example, by a driver which is part of the core of the operating system. Communication interface(s) 460 is, for example, a network card, a network module and/or a modem and is set up to connect charging unit 400 to a network. For example, communication interface(s) 460 may receive data over the network and forward it to the control circuit processor and/or receive data from the processor and send it over the network. Examples of a network are a local area network (LAN) such as an Ethernet network or an IEEE 802 network, a wide area network (WAN), a wireless network, a wired network, a cellular network, a telephone network, and/or the Internet.

Furthermore, the control circuit 410, which is provided as a processor, may control at least one user interface 470. User interface 470 is for example a keyboard, a mouse, a (e.g. touch sensitive) display, a microphone, a loudspeaker, a reading device, a drive and/or a camera. For example, user interface 470 may receive input from a user and forward it to the processor and/or receive and output information to the user (from the processor).

The control circuit 410 may, for example, gathered values for evaluation, wherein the values are received from the proximity sensor 450 and/or from the light sensor 490 and/or from the optional further sensor(s) 480.

For example, the control circuit 410 provided as a processor may generate control information for the display device 440. A generated control information may, for example, be relayed to the display device 440.

The display device 440 may comprise an optical fiber and a light source. The light source comprises, for example, one or more LEDs, OLEDs or the like for emitting light into the optical fiber. The display device may, for example, display generated control information, which are visualized for the user. The display device 440 or the optical fiber comprised by the display device 440 may be divided into at least two segments, in which information differing from one another may be displayed in particular by means of the at least two segments.

FIG. 5 shows a schematic cross-sectional view of a charging unit 520 according to an embodiment.

The 520 charging unit has a housing 560 and a basic body 550. A control circuit 510 is provided in the basic body. For example, control circuit 510 may be programmed to perform the method described above and below.

The control circuit 510 is usually a (micro-)processor that may perform a variety of functions. The control circuit 510 is connected to a proximity sensor 570, a light sensor 580, and optionally to one or more further sensors 590, for example via control lines. The sensors 570, 580, 590 are supplied with electrical power via the control lines and provide one or more measuring signals to the control circuit. The control circuit evaluates the signals, e.g. from the proximity sensor 570, and concludes that an object is approaching the proximity sensor 570. In the example shown, the proximity sensor 570 is arranged in the basic body 550.

In addition to the sensors 570, 580, 590, the control circuit 510 is also connected to the display device 530. In an exemplary embodiment, the display device 530 is divided into four segments, each of which may display different information to an owner or user of an electric vehicle. In order to enable this, the control circuit 510 is connected to a control line with the display device 530 respectively the light source 531 comprised by the display device 530. The four segments may be brought to light up differently by the control circuit for displaying the information, so that individual segments may be activated and may for example light up, while other segments remain inactive and do not light up. Optionally, this may be enabled by means of a light modulation.

The display device 530 may be arranged on the basic body 550 in such a way that it at least partially encircles the outer edge of the housing 560 and in particular projects into a recess (e.g. a groove) within the housing 560. The display device may be covered by parts of the housing 560.

In this case, at least parts of the housing 560 are made of a translucent material. The opacity is such that in regions in which light may shine through from the display 530, details of the display covered by the housing 560 and/or the basic body 550 covered by the housing 560 cannot be detected through the material.

The control circuit 510 is optionally connected to a user interface (not shown) via which inputs from a user may be transmitted from the user interface to the control circuit 510. In addition to controlling the display device 530 (e.g. the user wishes the display device to be switched on for lighting purposes), the user can also enter data for controlling the charging station via the user interface. For example, that he wants to start the charging of an electric vehicle connected to the charging station or the like.

The example embodiments described in the present specification and the optional features and characteristics respectively presented shall also be understood to be disclosed in combinations with each other. In particular, the disclosure of a feature of example embodiment—unless explicitly disclosed otherwise—should not be understood to mean that the feature is indispensable or essential for the function of the example embodiment. The sequence of the method steps described in this specification in the individual flow charts is not mandatory, alternative sequences of the method steps are conceivable. The method steps may be implemented in different ways, e.g. an implementation in software (by program instructions), hardware or a combination of both to implement the method steps is conceivable.

Terms used in patent claims such as “comprise”, “have”, “include”, “contain” and the like do not exclude other elements or steps. The expression “at least in part” covers both the case “in part” and the case “in full”. The wording “and/or” should be understood as meaning that both the alternative and the combination should be disclosed, i.e. “A and/or B” means “(A) or (B) or (A and B)”. The use of the indefinite article does not exclude a plurality. A single device can perform the functions of several units or devices mentioned in the patent claims. The reference signs indicated in the patent claims are not to be regarded as limitations of the means and steps used.

### REFERENCE SIGNS

100 charging station
110 base body
120 charging unit
130 display device
131 segment 1 of display device
132 Segment 2 of display device
133 Segment 3 of display device
134 Segment 4 of display device
135 variable segments 1 of display device
136 variable segments 2 of display device
141 user interface
142 proximity sensor
143 light sensor
144 optional further sensor or optional further sensors
145 connection for charging cable
150 basic body
160 housing
400 charging unit
410 control circuit
420 program memory
430 data memory
440 display device
450 proximity sensor
460 communication interface(s)
470 user interface
480 further sensor(s)
490 light sensor
510 control circuit
520 charging unit
530 display unit
531 light source
550 basic body
560 housing
570 proximity sensor
580 light sensor
590 optional further sensor or optional further sensors

1. A charging unit having
a basic body,
a housing at least partially surrounding the basic body, and
a display device for displaying a status, which display device is visible at least on the front side of the housing,
characterized in that
the charging unit comprises at least one proximity sensor and at least one light sensor, the proximity sensor detecting objects in the region of the outside of the housing, and the light sensor detecting a brightness and/or darkness in the region of the outside of the housing, wherein the charging unit is an interchangeable element and is detachable arranged on a charging station.

2. The charging unit according to claim 1, wherein the proximity sensor capacitively detects metallic and non-metallic objects.

3. The charging unit according to claim 1, wherein the proximity sensor detects movement of objects in the region of the outside of the housing.

4. The charging unit according to claim 1, wherein the proximity sensor is a radar sensor, a temperature sensor, or an ultrasonic sensor.

5. The charging unit according to claim 1, wherein the display device is arranged on the basic body and the housing is at least partially transparent at least in the region covering the display device.

6. The charging unit according to claim 1, wherein the display device comprises at least one optical fiber.

7. The charging unit according to claim 6, wherein one or more decoupling elements are arranged in a cavity formed by the at least one optical fiber, so that light can emerge from the optical fiber via the decoupling elements.

8. The charging unit according to claim 1, wherein the display device comprises at least one light source which emits light into one end of the at least one optical fiber.

9. The charging unit according to claim 8, wherein in a first region of the optical fiber facing the light source are provided a lower number of decoupling elements compared to a second region of the optical fiber being further away from the light source than the first region.

10. The charging unit according to claim 6, wherein the at least one optical fiber is divided into at least two segments, wherein in particular the at least two segments are configured to display information differing from one another.

11. The charging unit according to claim 7, wherein at least one of the following parameters of light emitted from the light source is adjustable:
(i) light temperature;
(ii) brightness;
(iii) color;
(iv) intensity;
(v) frequency;
(vi) or a combination thereof.

12. The charging unit according to claim 1, wherein the basic body comprises a control circuit, which detects one or more signals from the at least one proximity sensor and/or the at least one light sensor and/or a battery connected to the charging unit and at least partially generates control information for the display device based on the detected one or more signals.

13. The charging unit according to claim 12, wherein the display device displays information corresponding to the generated control information.

14. The charging unit according to claim 12, wherein the control information is indicative of at least one parameter for adjusting the light emitted from the light source.

15. The charging unit according to claim 1, wherein the display device comprises a diffuser for uniformly emitting light.
